(19) United States
(12) Patent Application Publication
(10) Pub. No.: US 2013/0276124 A1
(43) Pub. Date: Oct. 17, 2013

(54) SYSTEMS, METHODS, APPARATUSES AND COMPUTER PROGRAM PRODUCTS FOR PROVIDING MOBILE DEVICE PROTECTION

(71) Applicant: ASSURANT, INC., New York, NY (US)

(72) Inventors: Anis Tahir, Cheadle Hulme (GB); Baseer Zuberi, Wallington (GB); Chris Denison, Emberton (GB); Manjit Rana, West Bridgford (GB)

(21) Appl. No.: 13/832,962

(22) Filed: Mar. 15, 2013

Related U.S. Application Data
(60) Provisional application No. 61/625,472, filed on Apr. 17, 2012.

(51) Int. Cl. G06F 21/57

(52) U.S. Cl. CPC G06F 21/577
USPC 726/25

(57) ABSTRACT

Systems, methods, apparatuses and computer program products for providing mobile device protection. Some example embodiments provide for analyzing the current risks associated with a user's mobile device and providing solutions to improve the security of the mobile device. Further, some example embodiments provide for analysis of the hardware and software configuration of a mobile device, the applications installed on a mobile device, the accounts on a mobile device, the user data stored on or accessed from a mobile device, and/or the current location of a mobile device and then comparing this device data to known risk data to provide a user with an increased awareness of the current risks associated with a mobile device.

### CROSS REFERENCE TO RELATED APPLICATIONS

This application claims the benefit of priority to U.S. Provisional Application No. 61/625,472, which was entitled Systems, Methods, Apparatuses, and Computer Program Products for Providing Mobile Device Protection and was filed Apr. 17, 2012 and is hereby incorporated by reference in its entirety.

### TECHNOLOGICAL FIELD

Embodiments of the present invention relate generally to computer technology and, more particularly, relate to a system, method, apparatus, and computer program product for providing mobile device protection.

### BACKGROUND

As computing technology has continued to advance at a rapid pace, usage of mobile computing devices has become virtually ubiquitous amongst consumers. Today's mobile computing devices, including smartphones, tablet computing devices, and the like, possess power and capabilities previously only available on the most powerful personal computers. In particular, many mobile computing platforms, such as Apple iOS®, Android®, Windows® Phone, Blackberry®, and the like now enable users to install a variety of applications on their mobile devices. While in some cases these applications may be curated through application stores, quality and integrity reviews of applications available from application stores may not be able to fully guarantee the safety and interoperability of mobile applications. As such, the quality and relative safety of using some mobile applications is in question.

Further still, in many cases, users may access and store financial and social data and services on their mobile devices. This increased storage of a user's important or sensitive information on the user's mobile device, as well as increased media reports of data breaches, leads to an increased fear of the risk that the user's information may be illegally accessed or tampered with.

### BRIEF SUMMARY OF EXAMPLE EMBODIMENTS

Systems, methods, apparatuses and computer program products are disclosed herein for providing mobile device protection. In this regard, some example embodiments provide for analyzing the current risks associated with a user's mobile device and providing solutions to improve the security of the mobile device. Some example embodiments provide for analysis of the hardware and software configuration of a mobile device, the applications installed on the mobile device, the user data stored on or accessed from the mobile device, and the current location of the mobile device and then comparing this device data to known risk information to provide a user with an increased awareness of the current security risks. The system of some such example embodiments includes a mobile device protection apparatus configured to receive, store, and/or transmit mobile device data relating to the mobile device systems, applications, accounts, location, and/or the like. The mobile device protection apparatus of some example embodiments is configured to analyze this mobile device data in conjunction with a risk data pool to determine the current security risks associated with the mobile device and then transmit this risk data along with potential solutions to the mobile device. As such, the mobile device protection apparatus provided by some example embodiments provides proactive device monitoring to give mobile device users advance notice of and solutions for potential security risks identified on their mobile devices.

Some example embodiments provide a mobile application, which may be implemented on a mobile device. The mobile application of some example embodiments provides a stand-alone application configured to diagnose and provide solutions for issues potentially affecting the security of a mobile device. Additionally or alternatively, the mobile application of some example embodiments is configured to work in conjunction with a mobile device support apparatus by scanning mobile device data and conveying collected data to the mobile device support apparatus to facilitate remote analysis and diagnosis of any issues potentially affecting the security of a mobile device.

Some example embodiments additionally provide for storage of analyzed risks and solutions to provide for analysis of changes to mobile device data and to diagnose increased or decreased risk potential.

A further example embodiment is provided in the form of a method which includes receiving information regarding a system configuration of a mobile device and receiving information regarding a location of the mobile device. The method of the example embodiment may further include determining a risk profile by at least comparing the received information to known risk information and generating a risk report based at least in part on the risk profile, the risk report comprising a system risk component and a location risk component. The method of the example embodiment may also include causing the risk report to be presented via the mobile device. Another example embodiment in the form of a method may further include receiving information regarding one or more applications installed on the mobile device, wherein the risk report further comprises an application risk component.

An even further example embodiment is provided in the form of an apparatus which includes at least one processor and at least one memory storing program instructions. The at least one memory and program instructions of the example embodiment are configured to, with the at least one processor, direct the apparatus to at least receive information regarding a system configuration of a mobile device and receive information regarding a location of the mobile device. The apparatus of the example embodiment may be further directed to determine a risk profile by at least comparing the received information to known risk information and generating a risk report based at least in part on the risk profile, the risk report comprising a system risk component and a location risk component. The apparatus of the example embodiment may also be directed to cause the risk report to be presented via the mobile device. Another example embodiment in the form of an apparatus may further be directed to receive information regarding one or more applications installed on the mobile device, wherein the risk report further comprises an application risk component.

Yet another example embodiment is provided in the form of a computer program product including a non-transitory computer-readable storage medium having software instructions embodied therein. The software instructions of the example embodiment are configured to, upon execution, direct an apparatus to at least receive information regarding a system configuration of a mobile device and receive information regarding a location of the mobile device. The software instructions of the example embodiment are further configured to, upon execution, direct the apparatus to determine a risk profile by at least comparing the received information to known risk information and generating a risk report based at least in part on the risk profile, the risk report comprising a system risk component and a location risk component. The software instructions of the example embodiment are also configured to, upon execution, direct the apparatus to cause the risk report to be presented via the mobile device. The software instructions of another example embodiment may be further configured to, upon execution, direct the apparatus to receive information regarding one or more applications installed on the mobile device, wherein the risk report further comprises an application risk component.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates a system for providing mobile device protection according to some sample embodiments;

FIG. 2 illustrates a block diagram of a mobile device protection apparatus in accordance with some example embodiments;

FIG. 3 illustrates a block diagram of a mobile device in accordance with some example embodiments;

FIG. 4 illustrates a block diagram of the mobile device protection system according to some example embodiments;

FIG. 5 illustrates a block diagram of the mobile device protection system according to some example embodiments;

FIG. 6 illustrates a flowchart according to an example method for providing mobile device protection according to some example embodiments;

FIGS. 7-8 illustrate an example user interface that may be provided in accordance with some example embodiments;

FIGS. 9-12 illustrate example device risk alert interfaces that may be provided in accordance with some example embodiments;

FIGS. 13-14 illustrate example device risk analysis interfaces that may be provided in accordance with some example embodiments;

FIG. 15 illustrates an example user settings interface that may be provided in accordance with some example embodiments;

FIG. 16 illustrates a flowchart according to an example method operating at a mobile device for providing mobile device protection according to some example embodiments;

FIG. 17 illustrates a flowchart according to an example method operating at a mobile device protection apparatus for providing mobile device protection according to some example embodiments;

FIG. 18 illustrates a flowchart according to an example method for providing a device risk report according to some example embodiments; and

FIG. 19 illustrates a flowchart according to an example method for purchasing recommended protection applications according to some sample embodiments.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

As used herein, the terms “data,” “content,” “information” and similar terms may be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

### System Overview

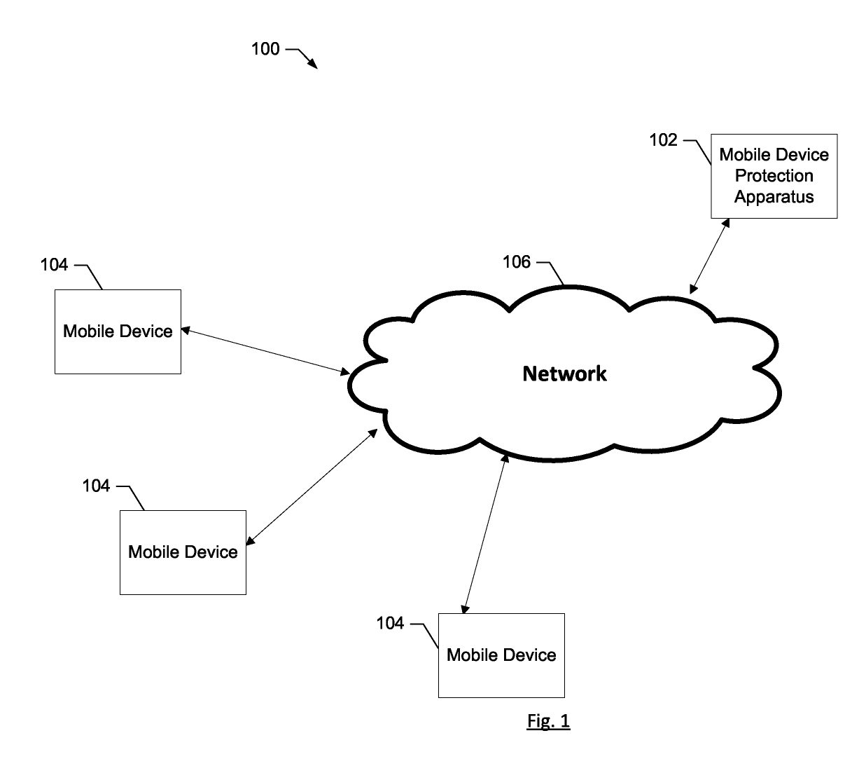

FIG. 1 illustrates a system 100 for providing mobile device protection according to some example embodiments. It will be appreciated that the system 100 as well as the illustrations in other figures are each provided as an example of an embodiment(s) and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a system for providing mobile device protection, numerous other configurations may also be used to implement embodiments of the present invention.

The system 100 may include a mobile device protection apparatus 102, which may be configured to provide mobile device protection to one or more mobile devices 104 via the network 106 in accordance with one or more example embodiments disclosed herein. The mobile device protection apparatus 102 may comprise one or more servers, a server cluster, one or more network nodes, a cloud computing infrastructure, one or more desktop computers, one or more laptop computers, some combination thereof, or the like.

As illustrated in FIG. 1, the system 100 may include one or more mobile devices 104. While three such mobile devices 104 are illustrated in FIG. 1, it will be appreciated that this illustration is by way of example, and not by way of limitation, as the system 100 may include additional or fewer mobile devices 104. A mobile device 104 may be embodied as any mobile computing device, such as by way of non-limiting example, a cellular phone, smart phone, mobile communication device, tablet computing device, digital camera/camcorder, mobile audio/video player, mobile digital video recorder, any combination thereof, or the like.

In various example embodiments, a mobile device 104 may be configured to connect to the network 106 via a variety of wireless and/or wireline connections. For example, a mobile device 104 may be configured to access the network 106 via a cellular connection, wireless local area network connection, Ethernet connection, and/or the like. As such, the network 106 may comprise a wireline network, wireless network (e.g., a cellular network, wireless local area network, wireless wide area network, some combination thereof, or the like), or a combination thereof, and in some example embodiments comprises at least a portion of the Internet.

In some example embodiments, the mobile device protection apparatus 102 and a mobile device 104 may be configured to communicate with each other over the network 106 to facilitate analysis by the mobile device protection apparatus 102 of mobile device risks and provision of risk solutions to the mobile device 104 in accordance with one or more example embodiments. The mobile device protection apparatus 102 may, for example, be maintained by a wireless carrier, mobile device manufacturer, mobile device warranty provider, mobile device insurance provider, and/or other entity that may provide protection services to mobile device users.

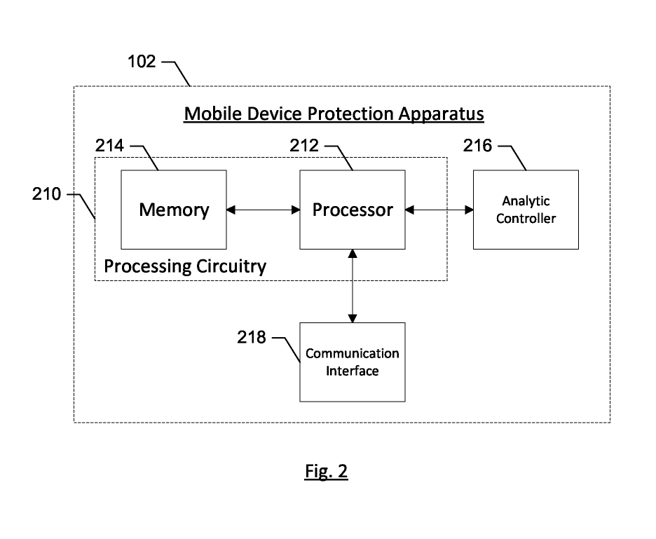

FIG. 2 illustrates a block diagram of a mobile device protection apparatus 102 in accordance with some example embodiments. However, it should be noted that the components, devices or elements illustrated in and described with respect to FIG. 2 below may not be mandatory and thus some may be omitted in certain embodiments. Additionally, some embodiments may include further or different components, devices or elements beyond those illustrated in and described with respect to FIG. 2.

Referring now to FIG. 2, the mobile device protection apparatus 102 may include or otherwise be in communication with processing circuitry 210 that is configurable to perform actions in accordance with one or more example embodiments disclosed herein. In this regard, the processing circuitry 210 may be configured to perform and/or control performance of one or more functionalities of the mobile device protection apparatus 102 in accordance with various example embodiments, and thus may provide means for performing functionalities of the mobile device protection apparatus 102 in accordance with various example embodiments. The processing circuitry 210 may be configured to perform data processing, application execution and/or other processing and management services according to one or more example embodiments. In some embodiments, the mobile device protection apparatus 102 or a portion(s) or component(s) thereof, such as the processing circuitry 210, may be embodied as or comprise a chip or chip set. In other words, the mobile device protection apparatus 102 or the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The mobile device protection apparatus 102 or the processing circuitry 210 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 210 may include a processing system, such as the processor 212 and, in some embodiments, such as that illustrated in FIG. 2, may further include memory 214. The processing circuitry 210 may be in communication with or otherwise control a communication interface 218 and/or an analytic controller 216. As such, the processing circuitry 210 may be embodied as a circuit chip (e.g., an integrated circuit chip) configured (e.g., with hardware, software or a combination of hardware and software) to perform operations described herein.

The processing system, e.g., processor 212, may be embodied in a number of different ways. For example, the processor 212 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 212 may comprise a plurality of processors. The plurality of processors may be in operative communication with each other and may be collectively configured to perform one or more functionalities of the mobile device protection apparatus 102 as described herein. The plurality of processors may be embodied on a single computing device or distributed across a plurality of computing devices collectively configured to function as the mobile device protection apparatus 102. In some example embodiments, the processor 212 may be configured to execute instructions stored in the memory 214 or otherwise accessible to the processor 212. As such, whether configured by hardware or by a combination of hardware and software, the processor 212 may represent an entity (e.g., physically embodied in circuitry—in the form of processing circuitry 210) capable of performing operations according to embodiments of the present invention while configured accordingly. Thus, for example, when the processor 212 is embodied as an ASIC, FPGA or the like, the processor 212 may be specifically configured hardware for conducting the operations described herein. Alternatively, as another example, when the processor 212 is embodied as an executor of software instructions, the instructions may specifically configure the processor 212 to perform one or more operations described herein.

In some example embodiments, the memory 214 may include one or more non-transitory memory devices such as, for example, volatile and/or non-volatile memory that may be either fixed or removable. In this regard, the memory 214 may comprise a non-transitory computer-readable storage medium. It will be appreciated that while the memory 214 is illustrated as a single memory, the memory 214 may comprise a plurality of memories. The plurality of memories may be embodied on a single computing device or may be distributed across a plurality of computing devices collectively configured to function as the mobile device protection apparatus 102. The memory 214 may be configured to store information, data, applications, instructions and/or the like for enabling the mobile device protection apparatus 102 to carry out various functions in accordance with one or more example embodiments. For example, the memory 214 may be configured to buffer input data for processing by the processor 212. Additionally or alternatively, the memory 214 may be configured to store instructions for execution by the processor 212. As yet another alternative, the memory 214 may include one or more databases that may store a variety of files, contents or data sets. Among the contents of the memory 214, applications may be stored for execution by the processor 212 in order to carry out the functionality associated with each respective application. In some cases, the memory 214 may be in communication with one or more of the processor 212, communication interface 218, or analytic controller 216 via a bus(es) for passing information among components of the mobile device protection apparatus 102.

The communication interface 218 may include one or more interface mechanisms for enabling communication with other devices and/or networks. In some cases, the communication interface 218 may be any means such as a device or circuitry embodied in either hardware, or a combination of hardware and software that is configured to receive and/or transmit data from/to a network and/or any other device or module in communication with the processing circuitry 210. By way of example, the communication interface 218 may be configured to enable the mobile device protection apparatus 102 to communicate with a mobile device(s) 104 and/or other computing device via the network 106. Accordingly, the communication interface 218 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the processor 212 (or the processing circuitry 210) may be embodied as, include, or otherwise control an analytic controller 216. As such, the analytic controller 216 may be embodied as various means, such as circuitry, hardware, a computer program product comprising computer readable program instructions stored on a computer readable medium (for example, the memory 214) and executed by a processing device (for example, the processor 212), or some combination thereof. The analytic controller 216 may be capable of communication with one or more of the memory 214 or communication interface 218 to access, receive, and/or send data as may be needed to perform one or more of the functionalities of the analytic controller 216 as described herein.

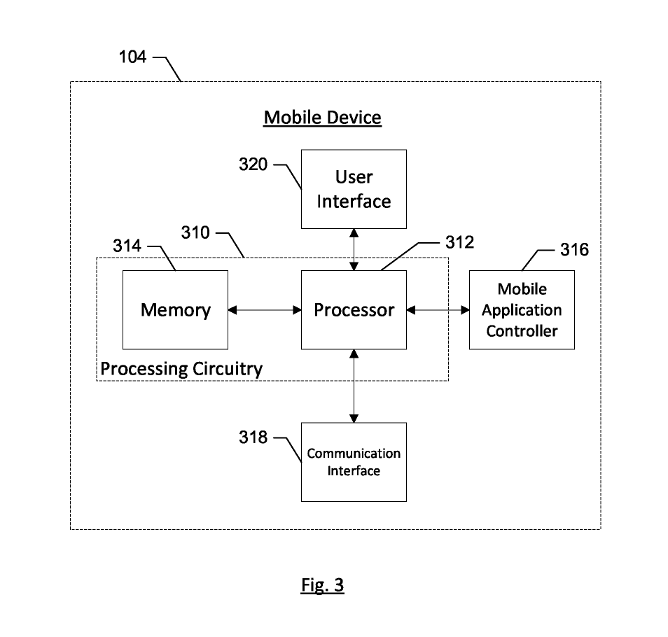

FIG. 3 illustrates a block diagram of a mobile device 104 in accordance with some example embodiments. However, it should be noted that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3.

Referring now to FIG. 3, the mobile device 104 may include or otherwise be in communication with processing circuitry 310 that is configurable to perform actions in accordance with one or more example embodiments disclosed herein. In this regard, the processing circuitry 310 may be configured to perform and/or control performance of one or more functionalities of the mobile device 104 in accordance with various example embodiments, and thus may provide means for performing functionalities of the mobile device 104 in accordance with various example embodiments. The processing circuitry 310 may be configured to perform data processing, application execution and/or other processing and management services according to one or more example embodiments. In some embodiments, the mobile device 104 or a portion(s) or component(s) thereof, such as the processing circuitry 310, may be embodied as or comprise a chip or chip set. In other words, the mobile device 104 or the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The mobile device 104 or the processing circuitry 310 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 310 may include a processor 312 and, in some embodiments, such as that illustrated in FIG. 3, may further include memory 314. The processing circuitry 310 may be in communication with or otherwise control a user interface 320, a communication interface 318, and/or a mobile application controller 316. As such, the processing circuitry 310 may be embodied as a circuit chip (e.g., an integrated circuit chip) configured (e.g., with hardware, software or a combination of hardware and software) to perform operations described herein.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 312 may comprise a plurality of processors. The plurality of processors may be in operative communication with each other and may be collectively configured to perform one or more functionalities of the mobile device 104 as described herein. In some example embodiments, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform one or more operations described herein.

In some example embodiments, the memory 314 may include one or more non-transitory memory devices such as, for example, volatile and/or non-volatile memory that may be either fixed or removable. In this regard, the memory 314 may comprise a non-transitory computer-readable storage medium. It will be appreciated that while the memory 314 is illustrated as a single memory, the memory 314 may comprise a plurality of memories. The memory 314 may be configured to store information, data, applications, instructions and/or the like for enabling the mobile device 104 to carry out various functions in accordance with one or more example embodiments. For example, the memory 314 may be configured to buffer input data for processing by the processor 312. Additionally or alternatively, the memory 314 may be configured to store instructions for execution by the processor 312. As yet another alternative, the memory 314 may include one or more databases that may store a variety of files, contents or data sets. Among the contents of the memory 314, applications may be stored for execution by the processor 312 in order to carry out the functionality associated with each respective application. In some cases, the memory 314 may be in communication with one or more of the processor 312, user interface 320, communication interface 318, or mobile application controller 316 via a bus(es) for passing information among components of the mobile device 104.

The user interface 320 may be in communication with the processing circuitry 310 to receive an indication of a user input at the user interface 320 and/or to provide an audible, visual, mechanical or other output to the user. As such, the user interface 320 may include, for example, a keyboard, a mouse, a joystick, a display, a touch screen display, a microphone, a speaker, and/or other input/output mechanisms. As such, the user interface 320 may, in some example embodiments, provide means for a user to access and interact with mobile device protection services provided by the mobile device protection apparatus 102 in accordance with various example embodiments.

The communication interface 318 may include one or more interface mechanisms for enabling communication with other devices and/or networks. In some cases, the communication interface 318 may be any means such as a device or circuitry embodied in either hardware, or a combination of hardware and software that is configured to receive and/or transmit data from/to a network and/or any other device or module in communication with the processing circuitry 310. By way of example, the communication interface 318 may be configured to enable the mobile device 104 to communicate with the mobile device protection apparatus 102 and/or other computing device via the network 106. Accordingly, the communication interface 318 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

In some example embodiments, the processor 312 (or the processing circuitry 310) may be embodied as, include, or otherwise control a mobile application controller 316. As such, the mobile application controller 316 may be embodied as various means, such as circuitry, hardware, a computer program product comprising computer readable program instructions stored on a computer readable medium (for example, the memory 314) and executed by a processing device (for example, the processor 312), or some combination thereof. The mobile application controller 316 may be capable of communication with one or more of the memory 314, user interface 320, or communication interface 318 to access, receive, and/or send data as may be needed to perform one or more of the functionalities of the mobile application controller 316 as described herein. In accordance with some example embodiments, the mobile application controller 316 may provide means for implementing and controlling functionality of a mobile application that may be configured to provide mobile device protection services, run diagnostics on the mobile device 104, and/or interact with the mobile device protection apparatus 102 in accordance with various example embodiments.

Having now generally described several embodiments of the system 100, mobile device protection services that may be provided by the system 100 will now be described in accordance with several example embodiments.

### Mobile Device Protection Services

Some example embodiments offer mobile device protections services facilitating the reduction of mobile device security risks and the increase of user confidence in use of the mobile device for personal and financial transactions. In accordance with various example embodiments, these services may, for example, be provided by the mobile device protection apparatus 102 under the control of the analytic controller 216, by a mobile application operating under the control of the mobile application controller 316, and/or some combination thereof.

In some example embodiments, the mobile application controller 316 may be configured to scan a mobile device 104 to collect device data related to the hardware and/or software configuration of the mobile device 104, the applications installed on the mobile device 104, the accounts on the mobile device 104, and/or the location data of the mobile device 104. The scanning may, for example, be performed periodically, on an ongoing basis, aperiodically, in accordance with a schedule, on demand, and/or the like. In this regard, the mobile application controller 316 may be configured proactively to automatically scan the mobile device 104 and/or may be configured to scan the mobile device 104 on-demand in response to a user request. In some example embodiments, scanning by the mobile application controller 316 may be performed under the control of and/or with the assistance of the mobile device protection apparatus 102.

In some example embodiments, scanning of device data for a mobile device 104 may be performed in accordance with configuration settings that may be user configured and/or automatically defined, such as during installation of a mobile application for providing mobile device protection services that may be provided in accordance with some sample embodiments. For example, configuration settings may define the type(s) of device data captured in the course of the scanning. In this regard, in some example embodiments, scanning may be tailored to capture only designated device data. As another example, configuration settings may guide the timing of device data scanning, frequency of device data scanning, and/or the like.

In various example embodiments, a variety of device data may be captured through scanning of the data on a mobile device 104. As one example, a device profile may be determined, which may include collected device data such as one or more of the hardware and/or software configurations, settings, security, connectivity, and/or the like of the mobile device 104; the applications installed on the mobile device 104; the configuration, settings, history, connectivity, phone access, and/or the like for installed applications on the mobile device 104; the security, connectivity, and/or the like of accounts on the mobile device 104; the location of the mobile device 104; and/or other data on the mobile device 104. In this regard, a device profile may provide a snapshot of device data which may include the system configuration, application configurations, account configurations, location data, and/or the like of a mobile device 104 and/or a state thereof at a given point in time. In some example embodiments, a series of device profiles may be determined over time, and one or more of the series of device profiles may be maintained, such as in memory 214 and/or in memory 314. The series of device profiles may be used to facilitate risk analysis, such as to identify a newly installed application, a modified device and/or application setting, account changes, location changes, and/or the like that may have impacted device protection.

In some example embodiments, collected device data may be at least temporarily maintained locally on a mobile device 104, such as in memory 314. Additionally or alternatively, in some example embodiments, at least a portion of collected device data for a mobile device 104 may be conveyed to the mobile device protection apparatus 102, where it may be maintained in memory 214. In embodiments in which device data is maintained at the mobile device protection apparatus 102, the device data may be maintained in a record, such as in a database, in association with a respective mobile device 104 from which it was captured.

In some example embodiments, collected device data may be used to perform device risk analysis for a mobile device 104 in order to identify potential security risks that may affect the mobile device 104. In some example embodiments, analysis may be performed entirely on the mobile device 104, such as by an application executing under the control of the mobile application controller 316. Additionally or alternatively, in some example embodiments, device risk analysis may be performed by the analytic controller 216 through performance of remote analysis on the mobile device 104 and/or based at least in part on device data for the mobile device 104 that may be provided to the mobile device protection apparatus 102 by the mobile device 104. As still a further example, in some example embodiments, device risk analysis may be performed both onboard the mobile device 104 and on the mobile device protection apparatus 102, such as in accordance with a distributed analysis process.

In performing device risk analysis, a variety of analytic techniques, heuristic techniques, and/or the like may be used to analyze collected device data. In some example embodiments, device risk analysis may be performed based on a risk data pool, such as may be stored on and/or otherwise accessible to the mobile device protection apparatus 102 and/or mobile device 104. In some example embodiments the risk data pool may include one or more of third-party risk data 416, which may include one or more of device security flaws, operating system security flaws, application security flaws, application upgrades, crime data, and/or the like, max security app profiles 414, recommended and/or reviewed protection applications 412, recommended changes to a device, account, and/or application setting, and/or other possible solution data. Further, in some example embodiments, device risk analysis may be additionally or alternatively performed based on device data that may be received by the mobile device protection apparatus 102 from a plurality of mobile devices 104. In this regard, the mobile device protection apparatus 102 may be configured to store the collected mobile device data associated with a particular mobile device for a plurality of mobile devices in a profile store. The mobile device protection apparatus 102 may be further configured to anonymously compare collected device data from a mobile device 104 with the plurality of stored collected device data in the profile store to perform device risk analysis for the particular mobile device 104 being analyzed.

In some example embodiments, device risk analysis may additionally or alternatively include comparing the location data from the collected device data to a data pool including geo-location crime data. In this regard, in some example embodiments, when a mobile device protection apparatus 102 receives collected device data from a mobile device 104 that includes a change in location data, the mobile device protection apparatus 102 may be configured to compare the location data to a data pool including crime statistics associated with location data. If the mobile device protection apparatus 102 determines that the comparison indicates that a determined type of criminal activity is above a certain threshold for the location data of the mobile device 104, the mobile device protection apparatus 102 may send an indication to the mobile device 104 to alert the user. The alert may be provided by the user interface 320 in any of a variety of form, such as, but not limited to a visual indication displayed on a display of the mobile device 104, an audible warning, a vibration of the mobile device 104, some combination thereof, or the like.

In some example embodiments, an indication of the identified risk may be provided to a user of the mobile device 104 in an instance in which a potential risk is identified from performance of device risk analysis on a mobile device 104. As an example, an alert notification, such as a graphical notification and/or an audible notification, indicative of an identified risk may be provided via the user interface 320, such as under the direction of the analytic controller 216 and/or the mobile application controller 316. Some examples of alert notifications that may be provided via a mobile device application are illustrated in FIG. 9, which is described further herein below.

In some example embodiments, the analytic controller 216 and/or the mobile application controller 316 may be configured to determine options for addressing an identified risk. As will be appreciated, the determined options for addressing an identified risk may vary based upon the type of risk identified. For example, an option may comprise changes to a device, account, and/or application setting that may be compromising mobile device protection. As another example, an option may comprise suggested installation of a reviewed and/or recommended protection application that may patch or otherwise resolve a potential risk. Reviewed and/or recommended protection applications may include applications such as anti-virus, anti-phishing, spyware/malware removal, data backup, device locator, data lock/wipe applications and/or the like.

In some instances, an option for addressing an identified risk may be automatically performed to remedy the potential risk. For example, device, application, and/or account settings may be automatically changed on the mobile device 104 in some example embodiments. Additionally or alternatively, a user may be provided with a list of one or more options for addressing an identified risk and may select an identified option to receive more information on the option and/or implement the option, as illustrated in FIGS. 9-12, which are described further herein below. For example, a mobile application operating under control of the mobile application controller 316 may prompt a user with an identified option via the user interface 320 and provide the user with the ability to implement the option. Additionally, the one or more identified options may include reviewed and/or recommended protection applications that may be purchased and/or installed by the user.

In some example embodiments, a device risk report may be provided to a mobile device 104, such as in an instance in which one or more potential risks are identified from performance of device risk analysis on a mobile device 104. A device risk report may include one or more of alerts for immediate risks, the types of potential risks associated with the mobile device, the significance of the risks, the impact of the risks, options for addressing the risks, an overall assessment of the risk level of the mobile device 104, a trend analysis of the risk level of the mobile device 104, a device risk profile score for the mobile device 104, a comparison to the risk profile scores of other mobile devices, and/or the like. In some example embodiments, a device risk report may comprise various components, such as a system risk component, a location risk component, and/or an application risk component. In some example embodiments, options for addressing the risks may include changes to a device, an account, and/or an application setting; recommended and/or reviewed protection applications as options for addressing the risks; and/or the like. Further, in some sample embodiments, the device risk reports may also include alerts as to security risks based on geo-location, such as in the location risk component of the device risk report.

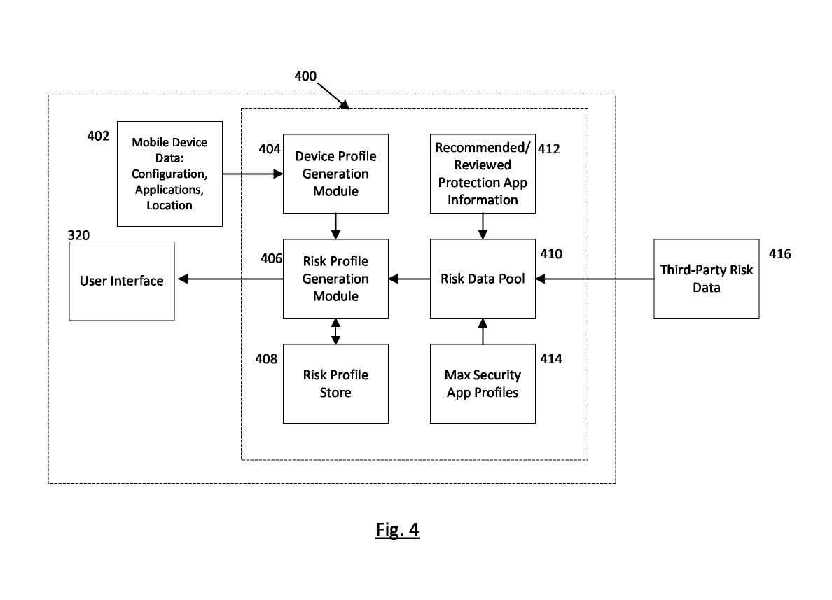

FIG. 4 illustrates a block diagram of a mobile device protection service 400 that may operate in system 100 to provide mobile device protection according to some example embodiments. The mobile device service 400 may be provided by the mobile device protection apparatus 102 under the control of the analytic controller 216, by a mobile application operating under the control of the mobile application controller 316, and/or some combination thereof. It will be appreciated, however, that the example mobile device protection service illustrated in FIG. 4 is provided by way of example, and not by way of limitation. In this regard, embodiments disclosed herein may provide systems having alternative selection, arrangement, and/or presentation of elements compared to those illustrated in the example service of FIG. 4.

Referring to FIG. 4, the mobile device protection service 400 of some example embodiments provides analysis of mobile device risks and provides device risk reports including a description of risks and potential solutions. The device profile generation module 404 may collect mobile device data 402 from the mobile device 104 and may generate a mobile device profile for use by the mobile device protection service 400 for risk analysis. The mobile device profile may be provided to the risk profile generation module 406 for risk analysis. The risk profile generation module 406 may compare the mobile device profile to known risk data stored in the risk data pool 410 to determine the potential risks associated with the mobile device profile. The potential risks may, for example, relate to one or more risk components such as system risk, location risk, and/or application risk. The risk data pool 410 may include data records pertaining to one or more of third-party risk data 416, which may include one or more of device security flaws, operating system security flaws, application security flaws, application upgrades, crime data, and/or the like, max security app profiles 414; recommended and/or reviewed protection applications 412; recommended changes to a device, account, and/or application setting; and/or other possible solution data. Risk profile generation module 406 may also anonymously compare the mobile device profile to a risk profile store 408 to determine potential risk trends and solutions. In this regard, the risk profile store 408 may store the device risk profiles for a plurality of mobile devices 104, which may be used to compare to the particular mobile device profile being analyzed by the risk profile generation module 406 to identify potential risks associated with the particular mobile device profile being analyzed.

Risk profile generation module 406 may generate a device risk report which may include one or more of alerts for immediate risks, the types of potential risks associated with the mobile device, the significance of the risks, the impact of the risks, options for addressing the risks, an overall assessment of the risk level of the mobile device 104, a trend analysis of the risk level of the mobile device 104, risk components, and/or the like. Risk profile generation module 406 may provide the device risk report, including the proposed solutions, to the mobile device user interface 320. Risk profile generation module 406 may also store the device risk profile to the risk profile store 408 for use in future risk analysis. Risk profile generation module 406 may further compare prior stored versions of the device risk profile for mobile device 104 as part of the device risk analysis. Thus, for example, the risk profile generation module 406 may determine a first risk profile at a first time and a second risk profile at a second time then generate a risk report based at least in part on the first and second risk profiles.

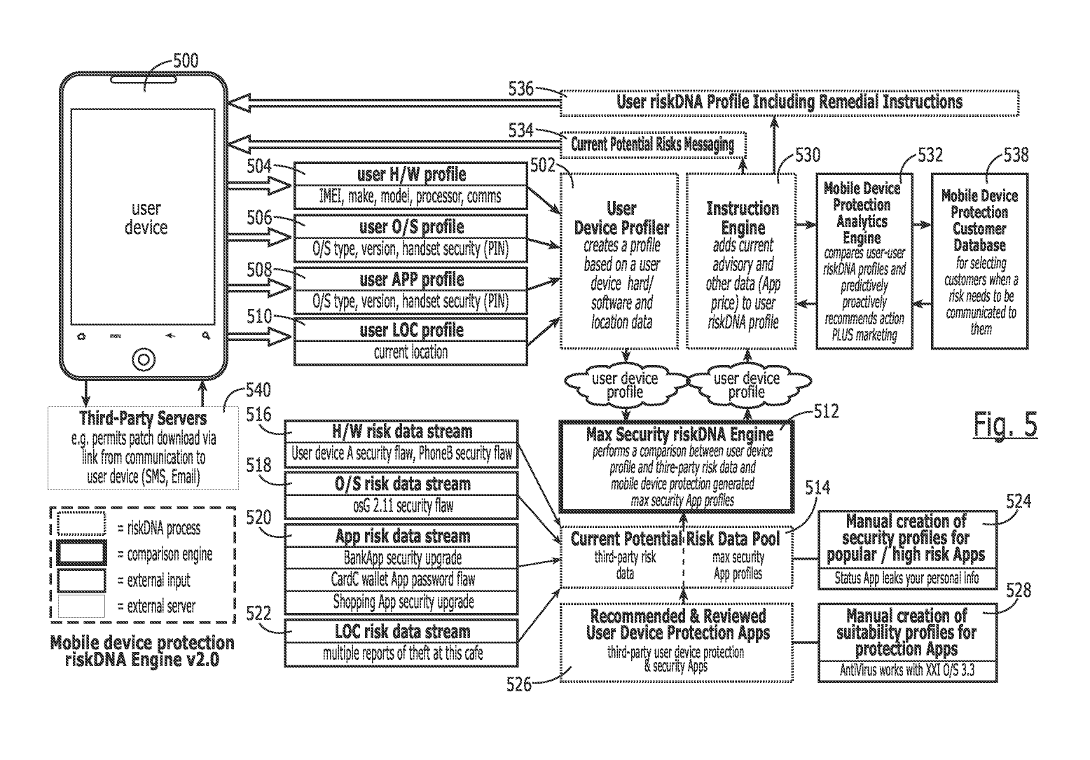

FIG. 5 further illustrates a block diagram of a mobile device protection system providing mobile device protection according to some example embodiments. It will be appreciated, however, that the example mobile device protection service illustrated in FIG. 5 is provided by way of example, and not by way of limitation. In this regard, embodiments disclosed herein may provide systems having alternative selection, arrangement, and/or presentation of elements compared to those illustrated in the example service of FIG. 5.

Referring to FIG. 5, the mobile device protection of some example embodiments provides analysis of mobile device risks and provides device risk reports including a description of risks, one or more risk components, and potential options for addressing an identified risk. The user smartphone profiler 502 may receive mobile device data which may include one or more of hardware profile data 504, operating system profile data 506, application profile data, 508, location profile data 510, and/or the like from the mobile device 500, which may, for example, comprise an embodiment of a mobile device 104, and may generate a mobile device profile for use by the mobile device protection system for risk analysis. The mobile device profile may be provided to the risk engine 512 for risk analysis. The risk engine 512 may compare the mobile device profile to known risk data stored in the risk data pool 514 to determine the potential risks associated with the mobile device profile and may create a device risk profile. The risk data pool 514 may contain data records pertaining to one or more of third-party risk data which may include hardware risk data 516, operating system risk data 518, application risk data 520, location risk data 522, and or the like, max security app profiles 524, recommended and/or reviewed protection applications 526, which may include suitability profiles 528 for the protection applications, and/or other possible options for addressing identified risks. Instruction engine 530 may add current alerts and other data to the device risk profile. The instruction engine 530 may also send the device risk profile to the analytics engine 532 to anonymously compare the device risk profile to other stored risk profiles to determine potential risk trends and options for addressing risks. The analytics engine 532 may also use the risk profile comparisons to determine other users that should be notified of an identified risk and retrieve the user information from the customer database 538 to generate the notification. The instruction engine 530 may provide live risk messaging 534 to the mobile device 500 for current risk alerts. The instruction engine 530 may also provide a device risk profile with remedial instructions 536, which may include one or more of the types of potential risks associated with the mobile device, the significance of the risks, the impact of the risks, options for addressing the risks, an overall assessment of the risk level of the mobile device 500, a trend analysis of the risk level of the mobile device 500, and/or the like, to the mobile device 500. There may also be third-party servers 540 that may provide updates directly to the mobile device 500.

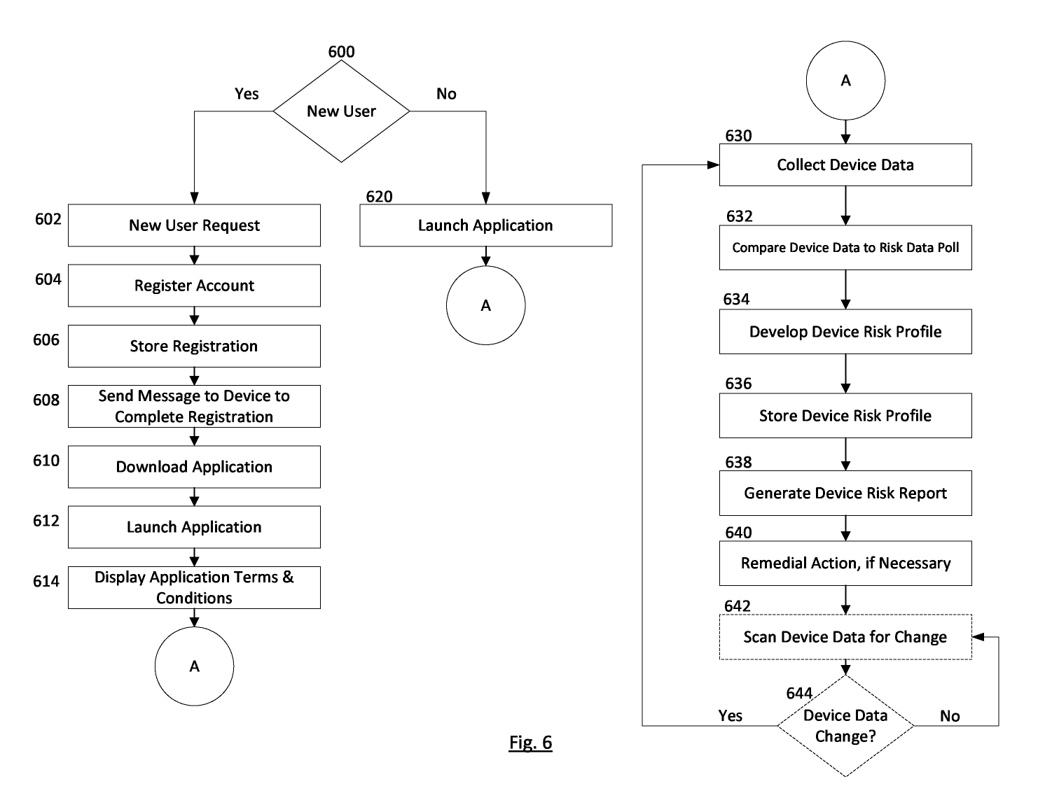

FIG. 6 illustrates a flowchart according to an example method for providing mobile device protection services according to some example embodiments. In this regard, FIG. 6 illustrates operations that may be performed at and/or by a mobile device protection apparatus 102 and/or a mobile device 104. The operations illustrated in and described with respect to FIG. 6 may, for example, be performed by, with the assistance of, and/or under the control of one or more of the processing circuitry 210, processor 212, memory 214, communication interface 218, analytic controller 216, processing circuitry 310, processor 312, memory 314, user interface 320, communication interface 318, or mobile application controller 316. Operation 600 may comprise determining if the operations are for a new user of the mobile device protection services. If the operations are for a new user (600—Yes), then Operation 602 may comprise sending a new user registration request. Operation 604 may comprise registering the new user with the mobile device protection services. Operation 606 may comprise storing the user registration. Operation 608 may comprise sending a message to the mobile device 104 to complete the registration for the new user. Operation 610 may comprise downloading and installing a mobile device protection application to the mobile device 104. Operation 612 may comprise launching the mobile device protection application on the mobile device 104. Operation 614 may comprise displaying the license, terms and conditions for the mobile device protection application on the user interface 320 of the mobile device 104. After the application license, terms and conditions have been displayed, the method may continue to Operation 630. If the operations are not for a new user (600—No), then Operation 620 may comprise launching the mobile device protection application on a mobile device 104, and the method then continues to Operation 630. Operation 630 may comprise collecting mobile device data, which may include one or more of the hardware and/or software configurations, settings, security, connectivity, and the like of the mobile device 104; the applications installed on the mobile device 104; the configuration, settings, history, connectivity, phone access, and the like for installed applications on the mobile device 104; the security, connectivity, and the like of accounts on the mobile device 104; the location of the mobile device 104; and/or the like. The processing circuitry 210, processor 212, memory 214, communication interface 218, analytic controller 216, processing circuitry 310, processor 312, memory 314, communication interface 318, and/or mobile application controller 316 may, for example, provide means for performing operation 630. Operation 632 may comprise performing device risk analysis based at least in part on collected mobile device data and a risk data pool to identify potential mobile device risks. The processing circuitry 210, processor 212, memory 214, communication interface 218, controller 220, processing circuitry 310, processor 312, memory 314, communication interface 318, and/or mobile application controller 316 may, for example, provide means for performing operation 632. Operation 634 may comprise developing a device risk profile based at least in part on the risk analysis performed in operation 632. The processing circuitry 210, processor 212, memory 214, communication interface 218, controller 220, processing circuitry 310, processor 312, memory 314, communication interface 318, and/or mobile application controller 316 may, for example, provide means for performing operation 634. Operation 636 may comprise storing the device risk profile in a risk profile store for future use. The processing circuitry 210, processor 212, memory 214, communication interface 218, controller 220, processing circuitry 310, processor 312, memory 314, communication interface 318, and/or mobile application controller 316 may, for example, provide means for performing operation 636. Operation 638 may comprise generating a device risk report based on the device risk profile which may include one or more of alerts for immediate risks, the types of potential risks associated with the mobile device, the significance of the risks, the impact of the risks, options for addressing the risks, an overall assessment of the risk level of the mobile device 104, a trend analysis of the risk level of the mobile device 104, and/or the like.

In some example embodiments, the device risk report generated in operation 638 may comprise one or more risk components, such as a system risk component, a location risk component, an application risk component, and/or other risk components. Such risk components may, for example, be used to group related risk information. Thus, for example the abovementioned one or more alerts for immediate risks, the types of potential risks associated with the mobile device, the significance of the risks, the impact of the risks, options for addressing the risks, an overall assessment of the risk level of the mobile device 104, a trend analysis of the risk level of the mobile device 104, and/or the like, may be grouped or categorized according to their corresponding applicable risk component. Thus, for example, all alerts relating to location risks may be included in a location risk component of the report, while all alerts relating to application risks may be included in an application risk component of the report. According to a further example embodiment in which the risk report includes a trend analysis of the risk level of the mobile device 104, such a trend analysis may include one or more risk components, such the trend analysis comprises a trend analysis of each of the various risk components.

In some example embodiments, options for addressing the risks may include changes to a device, account, and/or application setting, recommended and/or reviewed protection applications as options for addressing the risks, and/or the like. Further, in some sample embodiments, the device risk reports may also include alerts as to security risks based on geo-location. The processing circuitry 210, processor 212, memory 214, communication interface 218, controller 220, processing circuitry 310, processor 312, memory 314, communication interface 318, and/or mobile application controller 316 may, for example, provide means for performing operation 638. Operation 640 may comprise taking some action on the mobile device 104 based at least in part on the options for addressing risks that may be presented in the device risk report. The actions that may be taken in Operation 640 may comprise actions taken automatically on the mobile device 104 by the mobile device protection service or actions taken on the mobile device 104 at the direction of a user.

Optionally, operation 642 may comprise scanning mobile device data for changes that may potentially increase risk. Scanning mobile device data for changes may be performed periodically, on an ongoing basis, aperiodically, in accordance with a schedule, on demand, and/or the like. Operation 644 may determine whether there has been a change to mobile device data that may potentially increase risk. If a change has occurred that may potentially increase risk (644—Yes) then the method would return to operation 630 to begin the analysis process again to identify any new potential risks. If no change has occurred and/or a change has occurred that would not potentially increase risk (644—No), the method returns to operation 642 to continue scanning for changes, if required based on the configuration settings.

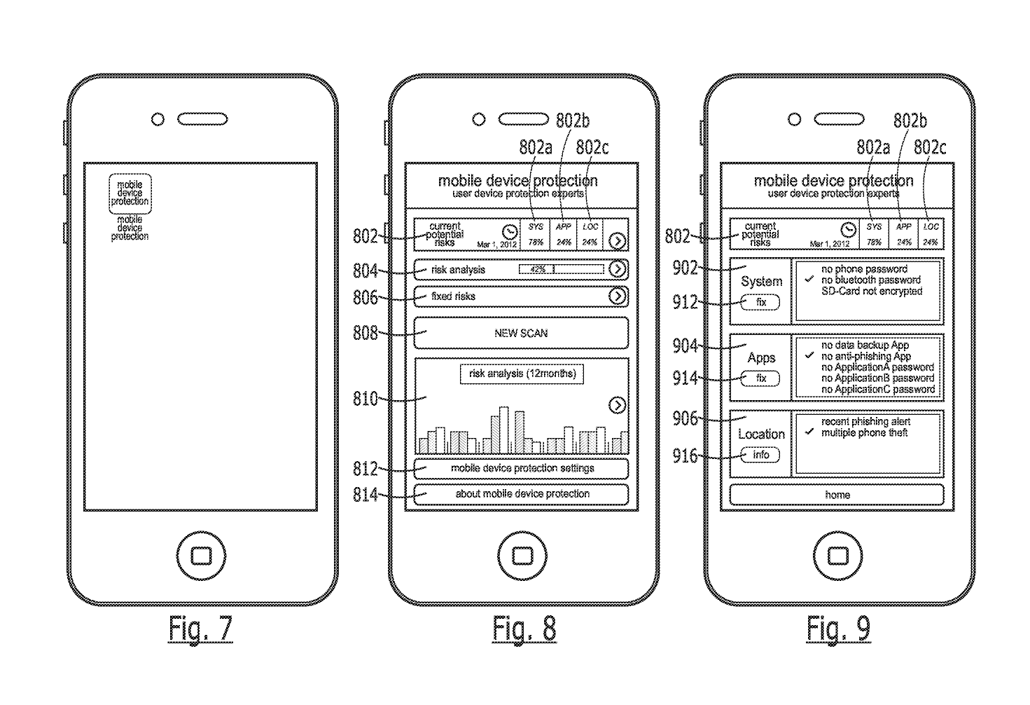

In some example embodiments, mobile device protection may be provided as part of a user-launchable application, such as may be accessed via an icon on a desktop, application menu, touch screen, and/or a like user interface. In this regard, FIG. 7 illustrates an example of an application icon on a user interface that may be used to launch a mobile device protection application, as provided in some example embodiments. It will be appreciated, however, that the example user interface illustrated in FIG. 7, as well as those illustrated in FIGS. 8-15 are each provided by way of example, and not by way of limitation. In this regard, embodiments disclosed herein may provide user interfaces having alternative selection, arrangement, and/or presentation of elements compared to those illustrated in the example user interface screen captures of FIGS. 7-15.

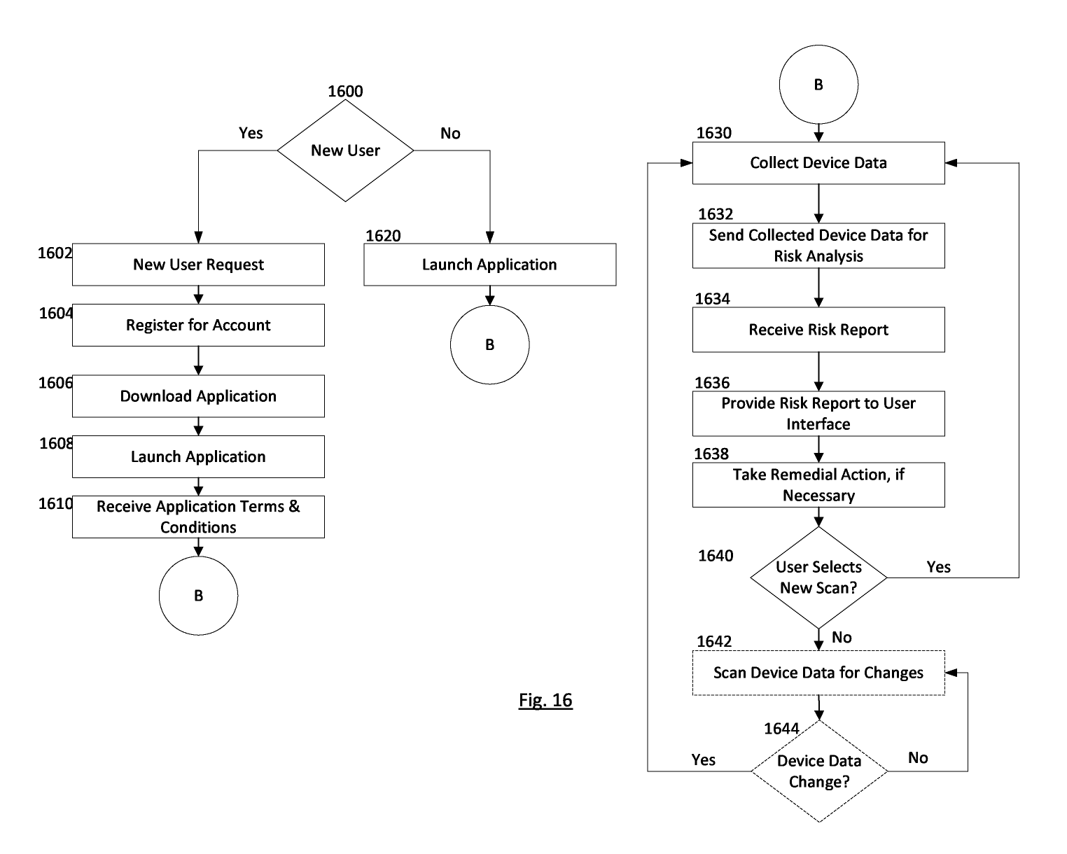

FIG. 8 illustrates an example mobile device protection user interface that may be provided in accordance with some example embodiments. In this regard, FIG. 8 illustrates an example user interface that may be provided on a user's mobile device 104. The example user interface of FIG. 8 may include an indication 802 of current potential risks identified through device risk analysis. The indication 802 of current potential risks may, for example, include indications of current potential risks related to one or more risk components, such as current potential system risks 802a, current potential application risks 802b, and/or current potential location risks 802c. The user may select to view and investigate the potential risks and solutions such as by touching the indication 802 in embodiments in which the user interface is illustrated on a touch screen display. In this regard, the user may be presented with more detail about the identified potential risks and/or proposed solutions for the identified potential risks, as illustrated in FIGS. 9-12. The example user interface of FIG. 8 may also include an indication 804 of the overall device risk level, and a user may select to view more detail of the analysis of the overall device risk level, as illustrated in FIGS. 13-14, by touching the indication 804 in embodiments in which the user interface is illustrated on a touch screen display. The example user interface of FIG. 8 may also include an indication 806 of risks that have been resolved previously, and a user may select to review and investigate the risks that have been resolved previously by touching the indication 806 in embodiments in which the user interface is illustrated on a touch screen display. The example user interface of FIG. 8 may also include an indication 808 that a user may request a new risk analysis of the mobile device by touching the indication 808 in embodiments in which the user interface is illustrated on a touch screen display. The example user interface of FIG. 8 may also include an indication 810 of the trend analysis of mobile device risks, and a user may select to view more detail of the analysis of the mobile device risk level, as illustrated in FIGS. 13-14, by touching the indication 810 in embodiments in which the user interface is illustrated on a touch screen display. The example user interface of FIG. 8 may also include an indication 812 that a user may view and/or change mobile device protection service settings, as illustrated in FIG. 15, by touching the indication 812 in embodiments in which the user interface is illustrated on a touch screen display. The example user interface of FIG. 8 may also include an indication 814 that a user may view information about the mobile device protection application by touching the indication 814 in embodiments in which the user interface is illustrated on a touch screen display.

FIG. 9 illustrates an example identified risks interface that may be provided in accordance with some example embodiments. In this regard, FIG. 9 illustrates an example user interface that may be provided on a user's mobile device 104 indicating device analysis results in accordance with some example embodiments.

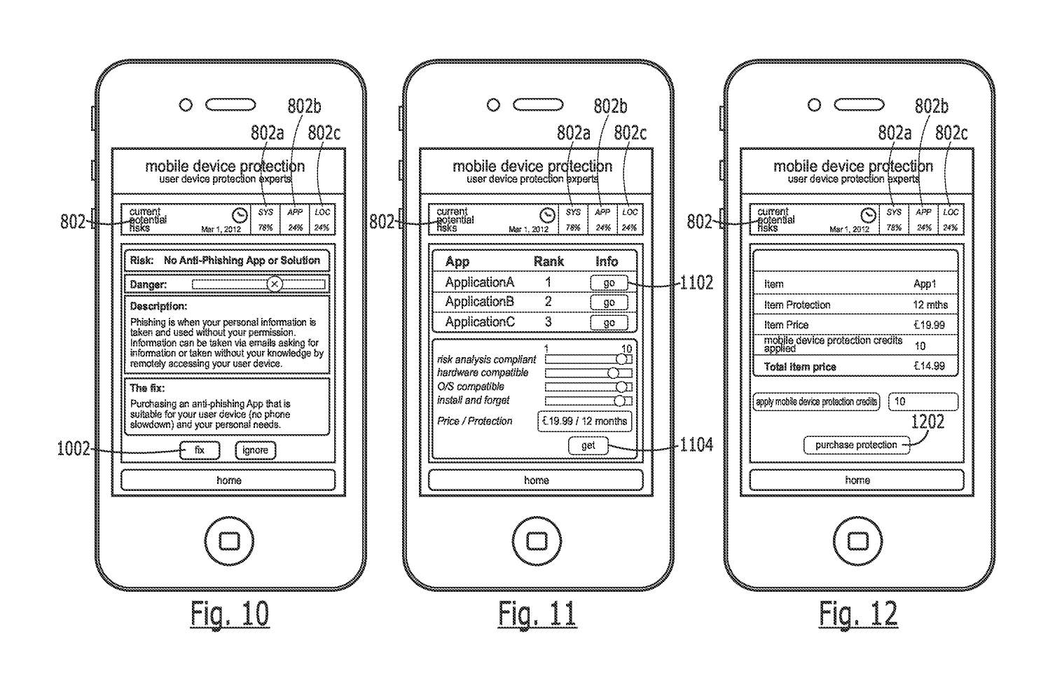

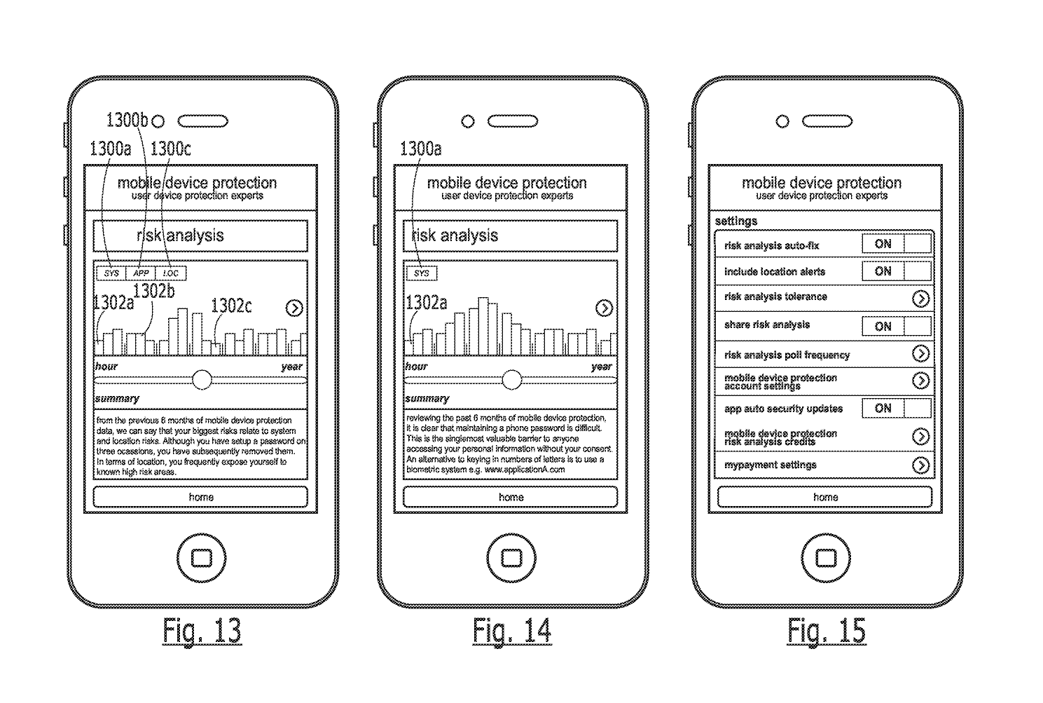

Referring to FIG. 9, the presentation of device risk analysis may include one or more indications of various risk components, such as an indication 902 of alerts relating to potential system risks, an indication 904 of alerts relating to potential application risks, and an indication 906 of alerts relating to potential location risks identified through performance of device risk analysis. The user may select to view and investigate the risks and solutions associated with the various risk components, as illustrated in FIGS. 10-12, such as by touching one of the buttons 912, 914, or 916 in embodiments in which the user interface is illustrated on a touch screen display. In this regard, the user may be presented with more detail about the identified potential risks and/or proposed solutions for the identified risks, as illustrated in FIG. 10. The user may select to further investigate the proposed solutions, as illustrated in FIG. 11, such as by touching the button 1002 in embodiments in which the user interface is illustrated on a touch screen display. Optionally, a user may select to view more detail about a suggested protection application, as illustrated in FIG. 12, by selecting button 1102 in embodiments in which the user interface is illustrated on a touch screen display. A user may choose to purchase the highest rated protection application by selecting button 1104 in embodiments in which the user interface is illustrated on a touch screen display. FIG. 12 illustrates the purchase details for a suggested protection application displayed as a result of the user selecting button 1102. A user may choose to purchase the displayed protection application by selecting button 1202 in embodiments in which the user interface is illustrated on a touch screen display.

FIGS. 13 and 14 illustrate example risk analysis overview interfaces that may be provided in accordance with some example embodiments. In this regard, FIGS. 13 and 14 illustrate example user interfaces that may be provided on a user's mobile device 104 indicating device analysis results, and specifically risk trend analysis, in accordance with some example embodiments. The risk trend analysis may, for example, comprise respective graphical representations of one or more risk profiles determined at different times. According to an example embodiment, the trend analysis may comprise respective graphical representations of one or more risk components, such as a system risk component 1302a, an application risk component 1302b, and/or a location risk component 1302c, such that the trend analysis comprises a respective trend analysis of each of the one or more risk components. According to an example embodiment, display of the graphical representations of the individual risk components may be toggled on or off, as illustrated in FIG. 14 in which only the system risk component 1302a is visible. Display of the various graphical representations of the individual risk components may be toggled, for example, in response to receiving selecting of one or more corresponding indicators, such as indicators 1300a, 1300b, or 1300c.

FIG. 15 illustrates an example user settings interface that may be provided in accordance with some example embodiments. In this regard, FIG. 15 illustrates an example user interface that may be provided on a user's mobile device 104 indicating device analysis results in accordance with some example embodiments. The user settings interface of FIG. 15 may allow a user to alter settings pertaining to the operation of the mobile device protection services.

FIG. 16 illustrates a flowchart according to an example method operating at a mobile device for providing mobile device protection according to some example embodiments. In this regard, FIG. 16 illustrates operations that may be performed at and/or by a mobile device 104. The operations illustrated in and described with respect to FIG. 16 may, for example, be performed by, with the assistance of, and/or under the control of one or more of the processing circuitry 310, processor 312, memory 314, user interface 320, communication interface 318, or mobile application controller 316. Operation 1600 may comprise determining if the operations are for a new user of the mobile device protection services. If the operations are for a new user (1600—Yes), then Operation 1602 may comprise sending a request to register a new user to the mobile device protection apparatus 102. Operation 1604 may comprise sending the new user registration information to the mobile device protection apparatus 102. Operation 1606 may comprise downloading and installing a mobile device protection application to the mobile device 104. Operation 1608 may comprise launching the mobile device protection application on the mobile device 104. Operation 1610 may comprise receiving the license, terms and conditions for the mobile device protection application and displaying on the user interface 320 of the mobile device 104. Once the application license, terms and conditions have been displayed, the method continues to Operation 1630. If the operations are not for a new user (1600—No), then Operation 620 may comprise launching the mobile device protection application on the mobile device 104, and the method then continues to Operation 1630. Operation 1630 may comprise collecting mobile device data. The collected mobile device data may, for example, include one or more of the hardware and/or software configurations, settings, security, connectivity, and/or the like of the mobile device 104; the applications installed on the mobile device 104; the configuration, settings, history, connectivity, phone access, and/or the like for installed applications on the mobile device 104; the security, connectivity, and/or the like of accounts on the mobile device 104; the location of the mobile device 104; and/or the like. The processing circuitry 310, processor 312, memory 314, communication interface 318, and/or mobile application controller 316 may, for example, provide means for performing operation 1630. Operation 1632 may comprise sending the collected mobile device data to the mobile device protection apparatus 102 for risk analysis. The processing circuitry 310, processor 312, memory 314, communication interface 318, and/or mobile application controller 316 may, for example, provide means for performing operation 1632. Operation 1634 may comprise receiving the generated risk report from the mobile device protection apparatus 102. The processing circuitry 310, processor 312, memory 314, communication interface 318, and/or mobile application controller 316 may, for example, provide means for performing operation 1634. Operation 1636 may comprise providing the data from the risk report to the user interface. The processing circuitry 310, processor 312, memory 314, communication interface 318, and/or mobile application controller 316 may, for example, provide means for performing operation 1636. Operation 1638 may comprise taking some action on the mobile device 104 based at least in part on the options for addressing risks that may be presented in the device risk report. The actions that may be taken in Operation 1638 may comprise actions taken automatically on the mobile device 104 by the mobile device protection service and/or actions taken on the mobile device 104 at the direction of a user. Operation 1640 may comprise selecting to perform a new scan on the mobile device 104. If the performance of a new scan is selected (1640—Yes), then the method may return to Operation 1630 to begin the scan process again. If the performance of a new scan is not selected (1640—No), then the method may optionally continue to Operation 1642 or the method may end.

The method may optionally further comprise operation 1642 and/or operation 1644. Operation 1642 may comprise scanning mobile device data for changes that may potentially increase risk. Scanning mobile device data for changes may be performed periodically, on an ongoing basis, aperiodically, in accordance with a schedule, on demand, and/or the like. Operation 1644 may determine whether there has been a change to mobile device data that may potentially increase risk. If a change has occurred that may potentially increase risk (1644—Yes) then the method would return to Operation 1630 to begin the analysis process again to identify any new potential risks. If no change has occurred and/or a change has occurred that would not potentially increase risk (1644—No), the method may optionally return to Operation 1642 to continue scanning for changes, according to the configuration settings.

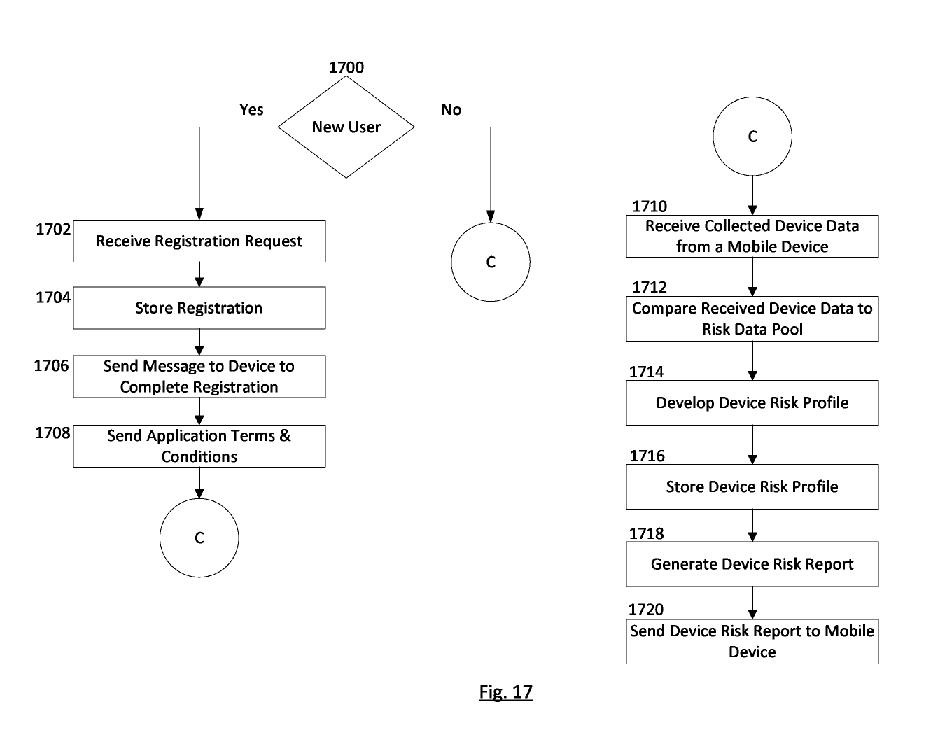

FIG. 17 illustrates a flowchart according to an example method operating at a mobile device protection apparatus for providing mobile device protection according to some example embodiments. In this regard, FIG. 17 illustrates operations that may be performed at and/or by a mobile device protection apparatus 102. The operations illustrated in and described with respect to FIG. 17 may, for example, be performed by, with the assistance of, and/or under the control of one or more of the processing circuitry 210, processor 212, memory 214, communication interface 218, and/or analytic controller 216. Operation 1700 may comprise determining if the operations are for a new user of the mobile device protection services. If the operations are for a new user (1700—Yes), then Operation 1702 may comprise receiving a new user registration request from the mobile device 104. Operation 1704 may comprise storing the new user registration. Operation 1706 may comprise sending a message to the mobile device 104 to complete the new user registration. Operation 1708 may comprise sending the license, terms and conditions for the mobile device protection application to the mobile device 104. The method may then continue to Operation 1710. If the operations are not for a new user (1700—No), then the method may then continue to Operation 1710. Operation 1710 may comprise receiving mobile device data from mobile device 104. The received data may, for example, include one or more of the hardware and/or software configurations, settings, security, connectivity, and/or the like of the mobile device 104; the applications installed on the mobile device 104; the configuration, settings, history, connectivity, phone access, and/or the like for installed applications on the mobile device 104; the security, connectivity, and/or the like of accounts on the mobile device 104; the location of the mobile device 104; and/or the like. The processing circuitry 210, processor 212, memory 214, communication interface 218, and/or analytic controller 216 may, for example, provide means for performing operation 1710. Operation 1712 may comprise performing device risk analysis based at least in part on collected mobile device data and a risk data pool to identify potential mobile device risks. The processing circuitry 210, processor 212, memory 214, communication interface 218, and/or analytic controller 216, may, for example, provide means for performing operation 1712. Operation 1714 may comprise developing a device risk profile based at least in part on the risk analysis performed in operation 1712. The processing circuitry 210, processor 212, memory 214, communication interface 218, and/or analytic controller 216 may, for example, provide means for performing operation 1714. Operation 1716 may comprise storing the device risk profile in a risk profile store for future use. The processing circuitry 210, processor 212, memory 214, communication interface 218, and/or analytic controller 216 may, for example, provide means for performing operation 1716. Operation 1718 may comprise generating a device risk report based on the device risk profile. The device risk report may, for example, include one or more of alerts for immediate risks, the types of potential risks associated with the mobile device, the significance of the risks, the impact of the risks, options for addressing the risks, an overall assessment of the risk level of the mobile device 104, a trend analysis of the risk level of the mobile device 104, and/or the like. In some example embodiments, options for addressing the risks may include changes to a device, account, and/or application setting, recommended and/or reviewed protection applications, and/or the like. Further, in some sample embodiments, the device risk reports may also include alerts as to security risks based on geo-location. The processing circuitry 210, processor 212, memory 214, communication interface 218, and/or analytic controller 216 may, for example, provide means for performing operation 1718. Operation 1720 may comprise sending the device risk report to the mobile device 104. The processing circuitry 210, processor 212, memory 214, communication interface 218, and/or analytic controller 216 may, for example, provide means for performing operation 1720.

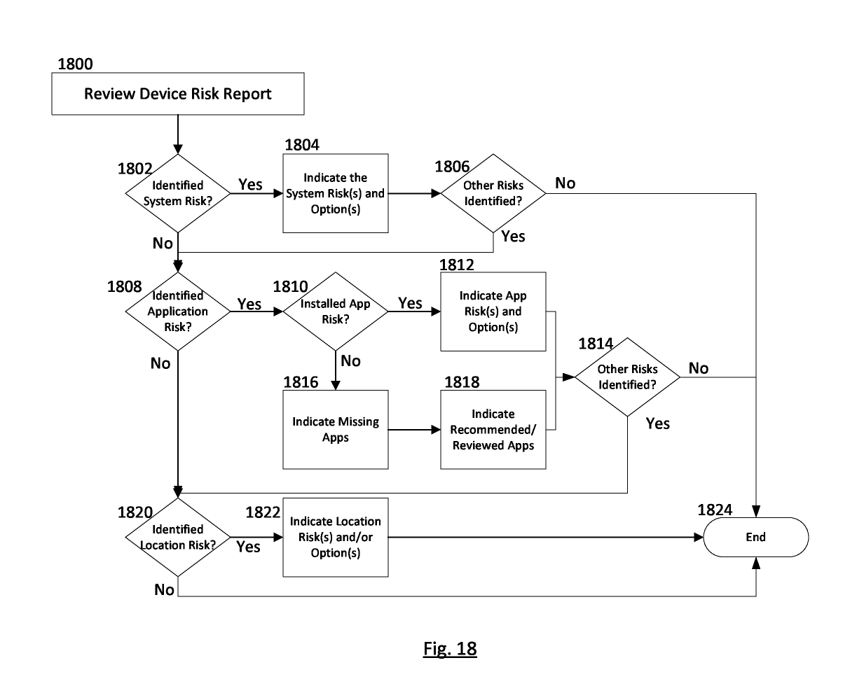

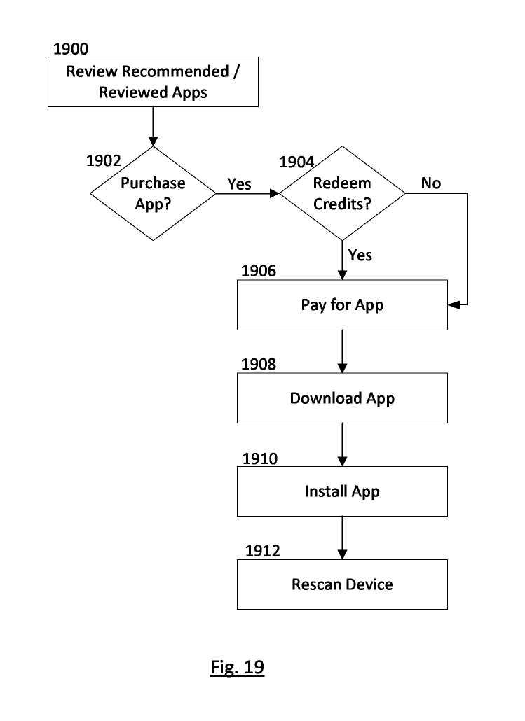

FIG. 18 illustrates a flowchart according to an example method for providing a device risk report according to some example embodiments. In this regard, FIG. 18 illustrates operations that may be performed at and/or by a mobile device 104. The operations illustrated in and described with respect to FIG. 18 may, for example, be performed by, with the assistance of, and/or under the control of one or more of the processing circuitry 310, processor 312, memory 314, user interface 320, communication interface 318, or mobile application controller 316. Operation 1800 may comprise selecting to view the device risk report on mobile device 104, such as by touching the indication 802 on the example user interface presented in FIG. 8. The processing circuitry 310, processor 312, memory 314, communication interface 318, and/or mobile application controller 316 may, for example, provide means for performing operation 1800. Operation 1802 may comprise determining if there are any identified system risks to be reviewed. The processing circuitry 310, processor 312, memory 314, communication interface 318, and/or mobile application controller 316 may, for example, provide means for performing operation 1802. If there are identified system risks to be reviewed (1802—Yes), the method may continue to Operation 1804. If there are no identified system risks to be reviewed (1802—No), the method may continue to Operation 1808. Operation 1804 may comprise presenting any identified system risks and options for addressing any risks on the user interface 320 of mobile device 104. The processing circuitry 310, processor 312, memory 314, communication interface 318, and/or mobile application controller 316 may, for example, provide means for performing operation 1804. Operation 1806 may comprise determining if there are any more identified risks that may be selected to be reviewed. The processing circuitry 310, processor 312, memory 314, communication interface 318, and/or mobile application controller 316 may, for example, provide means for performing operation 1806. If there are more identified risks to be reviewed (1806—Yes), the method may continue to Operation 1808. If, however, there are no more identified risks to be reviewed (1806—No), the method may continue to Operation 1824 and the method ends.

Operation 1808 may comprise determining if there are any identified application risks to be reviewed. The processing circuitry 310, processor 312, memory 314, communication interface 318, and/or mobile application controller 316 may, for example, provide means for performing operation 1808. If there are identified application risks to be reviewed (1808—Yes), the method may continue to Operation 1810. If there are no identified application risks to be reviewed (1808—No), the method may continue to Operation 1820. Operation 1810 may comprise determining if the identified application risks are associated with an application(s) already installed on mobile device 104. The processing circuitry 310, processor 312, memory 314, communication interface 318, and/or mobile application controller 316 may, for example, provide means for performing operation 1810. If the identified application risks are associated with an application(s) already installed (1810—Yes), the method may continue to Operation 1812. Operation 1812 may comprise presenting any identified application risks and options for addressing any risks on the user interface 320 of mobile device 104. The processing circuitry 310, processor 312, memory 314, communication interface 318, and/or mobile application controller 316 may, for example, provide means for performing operation 1812. If, however, the identified application risks are not associated with an application(s) already installed (1810—No), the method may continue to Operation 1816. Operation 1816 may comprise presenting categories of missing protection applications on the user interface 320 of mobile device 104. The processing circuitry 310, processor 312, memory 314, communication interface 318, and/or mobile application controller 316 may, for example, provide means for performing operation 1816. Operation 1818 may comprise presenting one or more recommended and/or reviewed protection applications that may be purchased and installed, based on the indicated missing protection application categories, on the user interface 320 of mobile device 104. The processing circuitry 310, processor 312, memory 314, communication interface 318, and/or mobile application controller 316 may, for example, provide means for performing operation 1818. Operation 1814 may comprise determining if there are any more identified risks that may be selected to be reviewed. The processing circuitry 310, processor 312, memory 314, communication interface 318, and/or mobile application controller 316 may, for example, provide means for performing operation 1814. If there are more identified risks to be reviewed (1814—Yes), the method may continue to Operation 1820. If, however, there are no more identified risks to be reviewed (1814—No), the method may continue to Operation 1824 and the method ends.

Operation 1820 may comprise determining if there are any identified location risks to be reviewed. The processing circuitry 310, processor 312, memory 314, communication interface 318, and/or mobile application controller 316 may, for example, provide means for performing operation 1820. If there are identified location risks to be reviewed (1820—Yes), the method may continue to Operation 1822. If, however, there are no identified location risks to be reviewed (1820—No), the method may continue to Operation 1824 and the method may conclude. Operation 1822 may comprise presenting any identified location risks and options for addressing any risks on the user interface 320 of mobile device 104. The processing circuitry 310, processor 312, memory 314, communication interface 318, and/or mobile application controller 316 may, for example, provide means for performing operation 1822. The method may continue to Operation 1824 and the method may conclude.

FIG. 19 illustrates a flowchart according to an example method for purchasing recommended protection applications according to some sample embodiments. In this regard, FIG. 19 illustrates operations that may be performed at and/or by a mobile device 104. The operations illustrated in and described with respect to FIG. 19 may, for example, be performed by, with the assistance of, and/or under the control of one or more of the processing circuitry 310, processor 312, memory 314, user interface 320, communication interface 318, or mobile application controller 316. Operation 1900 may comprise viewing the one or more recommended and/or reviewed protection applications that have been suggested by the mobile device protection service to address any missing protection application categories on the mobile device 104. The processing circuitry 310, processor 312, memory 314, communication interface 318, and/or mobile application controller 316 may, for example, provide means for performing operation 1900. Operation 1902 may comprise determining whether a user has selected to purchase a recommended and/or reviewed protection application. The processing circuitry 310, processor 312, memory 314, communication interface 318, and/or mobile application controller 316 may, for example, provide means for performing operation 1902. If a protection application is selected to be purchased (1902—Yes), then method may continue to Operation 1904. Operation 1904 may comprise determining whether a user has selected to redeem credits for the purchase of the protection application. The processing circuitry 310, processor 312, memory 314, communication interface 318, and/or mobile application controller 316 may, for example, provide means for performing operation 1904. If credits are to be redeemed for the purchase of the protection application (1904—Yes), then available credits may be subtracted from the purchase price of the protection application and the method may continue to Operation 1906. In this regard, a user of the mobile device protection application may acquire credits to be used for protection application purchases in various ways. For example, a new user may be given a number of initial credits upon installation of the mobile device protection application or a user may earn credits by recommending products to other users. If credits are not to be redeemed for the purchase of the protection application (1904—No), then the method may continue to Operation 1906. Operation 1906 may comprise paying for the selected protection application. The processing circuitry 310, processor 312, memory 314, communication interface 318, and/or mobile application controller 316 may, for example, provide means for performing operation 1906. Operation 1908 may comprise downloading the selected protection application to the mobile device 104. The processing circuitry 310, processor 312, memory 314, communication interface 318, and/or mobile application controller 316 may, for example, provide means for performing operation 1908. Operation 1910 may comprise installing the downloaded protection application on the mobile device 104. The processing circuitry 310, processor 312, memory 314, communication interface 318, and/or mobile application controller 316 may, for example, provide means for performing operation 1910. Operation 1912 may comprise rescanning the mobile device 104 to determine an updated device risk profile after the installation of the selected protection application. The processing circuitry 310, processor 312, memory 314, communication interface 318, and/or mobile application controller 316 may, for example, provide means for performing operation 1912.

Optionally, the systems, methods, apparatuses, and computer program products for providing mobile device protection may provide additional behind-the-scenes features. The mobile device protection system may provide information regarding intrusion activities to a user and/or appropriate authority. In this regard, the mobile device protection apparatus 102 may track potential intrusion activities associated with a mobile device 104, and based in part on configuration settings, notify a user, the provider of the mobile device protection services, an account provider, and/or other appropriate authorities. Additionally, the mobile device protection system may verify the status of a mobile device when a financial services application is downloaded and/or installed. In this regard, the mobile device protection apparatus 102 may compare a mobile device 104 downloading and/or installing a financial services application with a database of mobile devices that have been reported as lost, stolen, involved in an insurance claim and/or the like.

Additionally, in some example embodiments, while a device risk profile may be specific to a particular mobile device 104, the mobile device protection system may translate and/or transfer all or part of a device risk profile associated with a user's original mobile device to a device risk profile for a new or replacement mobile device provided to a user.

### CONCLUSION

FIGS. 6, 16, 17, 18, and 19 illustrate flowcharts of a system, method, and computer program product according to some example embodiments. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, the memory 214 and/or memory 314) storing instructions executable by a processor in the computing device (for example, by the processor 212 and/or processor 312). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, a mobile device protection apparatus 102, a mobile device 104 and/or other apparatus) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, a mobile device 104 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

It will thus be appreciated by those skilled in the art that example embodiments of the present invention provide a substantial, technical contribution to the prior art and, in particular, solve a technical problem, namely, how to analyze and present information regarding risks to a mobile device in a way that is intuitive and useful to a user. Moreover, example embodiments may provide further technical advantages, such as increasing device performance, reliability, and stability by providing intuitive tools for proactively identifying and addressing potential device risks.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving information regarding a system configuration of a mobile device;
receiving information regarding a location of the mobile device;
determining a risk profile by at least comparing the received information to known risk information;
generating a risk report based at least in part on the risk profile, the risk report comprising a system risk component and a location risk component; and
causing the risk report to be presented via the mobile device.

2. The method of claim 1, further comprising receiving information regarding applications installed on the mobile device, and wherein the risk report further comprises an application risk component.

3. The method of claim 2, wherein the application risk component comprises one or more of: one or more recommended protection applications, one or more recommended changes to one or more application settings, or one or more categories of missing protection applications.

4. The method of claim 3, further comprising receiving selection of at least one of the one or more recommended protection applications and, in response, providing for the purchase and/or installation of the selected application.

5. The method of claim 1, further comprising determining, based on the comparison of the received information to the known risk information, one or more identified potential risks.

6. The method of claim 5, wherein the risk report comprises one or more options for addressing the one or more identified potential risks.

7. The method of claim 1, wherein causing the risk report to be presented comprises causing respective graphical representations of the risk components to be displayed.

8. The method of claim 1, wherein causing the risk report to be presented comprises causing a graphical representation of an overall risk level of the mobile device to be displayed.

9. The method of claim 1, wherein receiving the information regarding the system configuration of the mobile device and receiving the information regarding the location of the mobile device comprises receiving, via a network, the information regarding the system configuration of the mobile device and the information regarding the location of the mobile device at a mobile device protection apparatus.

10. The method of claim 1, wherein the risk profile comprises a first risk profile determined at a first time, the method further comprising determining a second risk profile at a second time; and
further wherein generating the risk report based at least in part on the risk profile comprises generating the risk report based at least in part on the first and second risk profile, and
causing the risk report to be presented comprises causing respective graphical representations of the first and second risk profiles to be displayed.

11. The method of claim 10, wherein causing respective graphical representations of the first and second risk profiles to be displayed comprises causing the respective graphical representations of the first and second risk profiles to be displayed via a timeline.

12. The method of claim 10, wherein causing respective graphical representations of the first and second risk profiles to be displayed comprises causing respective graphical representations of system and location components of the first and second risk profiles to be displayed via a timeline.

13. An apparatus comprising at least one processor and at least one memory storing program instructions, the at least one memory and program instructions being configured to, with the at least one processor, direct the apparatus to at least:
receive information regarding a system configuration of a mobile device;
receive information regarding a location of the mobile device;
determine a risk profile by at least comparing the received information to known risk information;
generate a risk report based at least in part on the risk profile, the risk report comprising a system risk component and a location risk component; and
cause the risk report to be presented via the mobile device.

14. The apparatus of claim 13, wherein the apparatus is further directed to receive information regarding applications installed on the mobile device, and wherein the risk report further comprises an application risk component.

15. The apparatus of claim 13, wherein the apparatus is directed to cause the risk report to be presented by causing respective graphical representations of the risk components to be displayed.

16. The apparatus of claim 13, wherein the risk profile comprises a first risk profile determined at a first time, the apparatus being further directed to determine a second risk profile at a second time; and
further wherein the apparatus is directed to generate the risk report based at least in part on the risk profile by generating the risk report based at least in part on the first and second risk profile, and
the apparatus is directed to cause the risk report to be presented by causing respective graphical representations of the first and second risk profiles to be displayed.

17. A computer program product comprising a non-transitory computer-readable storage medium having software instructions embodied therein, the software instructions being configured to, upon execution, direct an apparatus to at least:
receive information regarding a system configuration of a mobile device;
receive information regarding a location of the mobile device;
determine a risk profile by at least comparing the received information to known risk information;
generate a risk report based at least in part on the risk profile, the risk report comprising a system risk component and a location risk component; and
cause the risk report to be presented via the mobile device.

18. The computer program product of claim 17, wherein the apparatus is further directed to receive information regarding applications installed on the mobile device, and wherein the risk report further comprises an application risk component.

19. The computer program product of claim 17, wherein the apparatus is directed to cause the risk report to be presented by causing respective graphical representations of the risk components to be displayed.

20. The computer program product of claim 17, wherein the risk profile comprises a first risk profile determined at a first time, the apparatus being further directed to determine a second risk profile at a second time; and
further wherein the apparatus is directed to generate the risk report based at least in part on the risk profile by generating the risk report based at least in part on the first and second risk profile, and
the apparatus is directed to cause the risk report to be presented by causing respective graphical representations of the first and second risk profiles to be displayed.
